(19) United States
(12) Patent Application Publication
(10) Pub. No.: US 2025/0335996 A1
(43) Pub. Date: Oct. 30, 2025

(54) CONTEXTUAL UNDERWRITING ANALYTICS ENGINE IN A FINANCIAL MANAGEMENT SYSTEM

(71) Applicant: Abraham Anthony DAIRI, Beverly Hills, CA (US)

(72) Inventor: Abraham Anthony DAIRI, Beverly Hills, CA (US)

(21) Appl. No.: 18/647,477

(22) Filed: Apr. 26, 2024

(51) Int. Cl. G06Q 40/06; G06Q 40/10

(52) U.S. Cl. CPC G06Q 40/06; G06Q 40/10

(57) ABSTRACT

Methods, systems, and computer storage media for providing context-based underwriting using a contextual underwriting analytics engine of a financial management system. Context-based underwriting includes performing a lending and credit assessment based on both contextual factors and augmented analytics rules in generating underwriting recommendations. In operation, input data of an entity is accessed at a contextual underwriting analytics engine. The input data is associated with an underwriting assessment of raw financial documents of the entity. The input data is analyzed using the contextual underwriting analytics engine comprising a contextual underwriting analytics model and a plurality of predefined augmented analytics rules. Based on analyzing the input data, generating an underwriting analytics recommendation associated with one or more fields of a raw financial document and a predefined augmented analytics rule. The underwriting analytics recommendation is communicated for presentation on a contextual underwriting analytics interface. The underwriting analytics recommendation comprising a human-readable contextual insight.

### BACKGROUND

Individuals, businesses, and organizations use financial management systems to manage their financial operations effectively. A financial management system offers a range of features to streamline various financial tasks, including accounting, budgeting, financial reporting, and analysis. In particular, the financial management system can provide analytics and decision support tools to analyze financial data and trends, identify opportunities for cost savings or revenue growth, and make data-driven decisions. For example, the financial management tool can include tools for financial modeling, scenario analysis, and key performance indicators (KPIs) tracking. Financial management tools assist in efficiently managing financial resources, maintain accurate financial records, and make informed financial decisions to achieve identified business objectives.

### SUMMARY

Various aspects of the technology described herein are generally directed to systems, methods, and computer storage media for, among other things, providing context-based underwriting using a contextual underwriting analytics engine of a financial management system. Financial management generally refers to planning, organizing, controlling, and monitoring of financial resources. Context-based underwriting includes performing a lending and credit assessment that allows for a comprehensive consideration of contextual factors and augmented analytics rules in generating contextual underwriting analytics recommendations. In this way, the contextual underwriting analytics recommendation is a data-driven assessment that integrates traditional underwriting criteria with additional contextual factors and advanced analytics insights to evaluate the creditworthiness or risk associated with a financial transaction or application. The contextual underwriting analytics recommendation leverages a comprehensive understanding of an individual's financial profile to generate personalized recommendations and insights aimed at optimizing risk assessment and decision outcomes.

The contextual underwriting analytics engine operates based on both qualitative client profile data and quantitative client financial data to provide a comprehensive analysis for underwriting purposes. The contextual underwriting analytics engine begins by incorporating qualitative client profile data-client profile description, such as biographies and financial goals—to set the contextual stage for the analysis. This qualitative client profile data adds depth to the assessment, allowing analysts to understand the client's background and aspirations. Subsequently, the contextual underwriting analytics engine applies a set of rules that utilize the qualitative client profile data to interpret the quantitative client financial data. For example, it may extract relevant insights from the client's professional goals, business structure and investment objectives and map them to tax returns and financial statements, based on augmented analytics rules. These rules enable the system to generate insightful narratives that bridge the gap between historical financial performance and future projections. Ultimately, by integrating both qualitative client profile data and quantitative client financial data, the system facilitates a more informed and nuanced underwriting process, empowering analysts to make comprehensive assessments aligned with the client's broader narrative.

Conventional financial management systems are not configured with comprehensive logic to provide contextual and automated analysis of financial documents along with human-readable additional insights that explain to the user an appropriate context-specific way why certain data and computations are relevant for an underwriter's assessment. In particular, an underwriter may have to manually extract information from financial documents into a spreadsheet to support evaluating creditworthiness. Even if the extraction of information were automated, the conventional financial management systems do not explain what fields are relevant-alone or in combination with other fields in one or more financial documents or in combination with qualitative client profile data—to support how the underwriter evaluates a potential borrower. Financial management systems lack the analytical know-how (i.e., contextual underwriting computations and mapping of human-readable insights to contexts) and user-friendly interfaces to automate filtering of essential information to a financial management system interface and providing additional context for the filtered information.

A technical solution—to the limitations of conventional financial management systems—can include providing contextual underwriting analytics resources via a contextual underwriting analytics engine that supports context-based underwriting in a financial management system. Contextual underwriting analytics resources can include operations for generating contextual underwriting analytics recommendations that include human-readable contextual insights based on predefined augmented analytics rules. The underwriting analytics recommendation can further include actual or potential calculations based on the predefined augmented analytics rules. An augmented analytic rule can refer to a predefined algorithm, logic, and process that is implemented within the contextual underwriting analytics engine to automate data analysis, generate insights, and support decision-making. The rules incorporate advanced analytics techniques, such as machine learning and natural language processing, to enhance the analysis of data and provide actionable insights. Moreover, the contextual underwriting analytics engine can support data exportation functionality that is based on the contextual underwriting analytics recommendations to package and communicate an underwriting output to an external system.

In operation, input data of an entity is accessed at a contextual underwriting analytics engine. The input data is associated with a client identified for an underwriting assessment, the input data comprising qualitative client profile data including a client financial profile description and quantitative client financial data including one or more raw financial documents. The input data is analyzed using the contextual underwriting analytics engine comprising a contextual underwriting analytics model and a plurality of predefined augmented analytics rules. Based on analyzing the input data, a contextual underwriting analytics recommendation associated with information from the client financial profile description, one or more fields of a raw financial document, and a predefined augmented analytics rule is generated. The contextual underwriting analytics recommendation is communicated for presentation on a contextual underwriting analytics interface. The underwriting analytics recommendation comprising a human-readable contextual insight.

In a second embodiment, a request for a contextual underwriting analytics recommendation for a client is communicated from a financial management client. Based on the request, the contextual underwriting analytics recommendation associated with information from the client financial profile description, one or more fields of a raw financial document, and a predefined augmented analytics rule is received. The underwriting analytics recommendation is caused to be displayed. The underwriting analytics recommendation comprising a human-readable contextual insight.

In a third embodiment, a plurality of contextual underwriting analytics recommendations for a client is accessed. Using a contextual underwriting analytics model and a plurality of predefined augmented analytics rules, a contextual underwriting analytics export package is generated. The contextual underwriting analytics export package is communicated to an external system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of an exemplary financial management system including a contextual underwriting analytics engine, in accordance with aspects of the technology described herein;

FIG. 2 is a flow diagram associated with an exemplary financial management system including a contextual underwriting analytics engine, in accordance with aspects of the technology described herein;

FIG. 3 provides a first exemplary method of providing context-based underwriting using a contextual underwriting analytics engine, in accordance with aspects of the technology described herein;

FIG. 4 provides a second exemplary method of providing context-based underwriting using a contextual underwriting analytics engine, in accordance with aspects of the technology described herein;

FIG. 5 provides a third exemplary method of providing context-based underwriting using a contextual underwriting analytics engine, in accordance with aspects of the technology described herein;

FIG. 6 provides a block diagram of an exemplary financial management system suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

A financial management system is designed to help individuals, businesses, or organizations manage their financial operations effectively. The financial management system provides a range of features to streamline various financial tasks, including accounting, budgeting, financial reporting, and analysis. For example, a financial management system can include analytics tools to analyze financial data and trends, identify opportunities for cost savings or revenue growth, and make data-driven decisions. In this way, a financial management systems can include tools for financial modeling, scenario analysis, key performance indicators (KPI) tracking, and underwriting.

By way of context, underwriting or credit underwriting can refer to a process that a lender or financial institution uses to evaluate the creditworthiness of a potential borrower. It is a central step in the lending process, whether the loan is for an individual, a business, or any other entity seeking to borrow funds. The primary goals of credit underwriting is to assess the risk associated with lending money and to make informed decisions about whether to approve or decline a loan application. A credit underwriting process begins with an analysis of the loan application that includes reviewing the borrower's financial information, credit history, employment status, and other relevant details. The borrower typically provides documents such as tax returns, pay stubs, and bank statements.

The financial information can be reviewed by an underwriting analyst or underwriter, who assesses and evaluates the creditworthiness of individuals, businesses or other entities seeking loans or credit from a financial institution. The underwriter may determine a credit score, debt-to-income ratio, loan-to-value ratio, cash flow analysis, profitability ratios, working capital, current ratio, quick-ration (acid-test ratio), debt service coverage ratio, and capital adequacy ratios as factors when evaluating financial information. Moreover, different lenders may have different ways of evaluating the financial information for final determination of creditworthiness. For example, add back depreciation only (i.e., isolate cash flow generated by core operations) and add back depreciation and interest (i.e., looking at the cash generated from operations without considering the non-operating costs associated with both financing and depreciation).

Conventional financial management systems are not configured with comprehensive logic to provide contextual and automated analysis of financial documents along with human-readable additional insights that explain to a user an appropriate context-specific way why certain data and computations are relevant for an underwriter's assessment. In particular, an underwriter may have to manually extract information from financial documents into a spreadsheet to support evaluating creditworthiness. Even if the extraction of information were automated, the conventional financial management systems do not explain what fields are relevant-alone or in combination with other fields in one or more financial documents or in combination with qualitative client profile data—to support how the underwriter evaluates a potential borrower. Financial management systems lack the analytical know-how (i.e., contextual underwriting computations and mapping of human-readable insights to contexts) and user-friendly interfaces to automate filtering of essential information to a financial management system interface and providing additional context for the filtered information.

For example, line 14C in a K-1 tax form can be used to report a partner's share of “tax-exempt income and nondeductible expenses”—to allocate these items to the individual partner so they are correctly reflected in the partner's overall tax situation. Partners may need to include this information on their overall tax returns and adjust their taxable income. Currently, an underwriter would have to manually evaluate the impact of a dollar amount associated with 14C on the potential borrower.

Moreover, if the potential borrower has additional K-1s (e.g., a first K-1 and a second K-1) that implicate the dollar amount in 14C, it becomes another manual process to make this connection and with a financial management system that does not provide any guidance or warning about this potential connection and an overall impact on a loan. Additionally, conventional financial management systems do not generate deliverables (e.g., underwriter reports) that include financial information filtered and summarized in a particular manner that can be shared along with raw financial documents (i.e., tax forms, W2s, and K-1s) in a way that is user friendly and ready to be imported and viewed in other different systems. As such, a more comprehensive financial management system-having an alternative basis for providing contextual underwriting analytics resources can improve operations and interfaces in a financial management system.

Embodiment of the present technical solution are directed to systems, methods, and computer storage media for, among other things, providing context-based underwriting using a contextual underwriting analytics engine of a financial management system. Financial management generally refers to planning, organizing, controlling, and monitoring of financial resources. Context-based underwriting includes performing a lending and credit assessment that allows for a comprehensive consideration of contextual factors and augmented analytics rules in generating contextual underwriting analytics recommendations. In this way, the underwriting recommendation is a data-driven assessment that integrates traditional underwriting criteria with additional contextual factors and advanced analytics insights to evaluate the creditworthiness or risk associated with a financial transaction or application. The contextual underwriting analytics recommendation leverages a comprehensive understanding of an individual's financial profile to generate personalized recommendations and insights aimed at optimizing risk assessment and decision outcomes. Context-based underwriting is provided using the contextual underwriting analytics engine that is operationally integrated into the financial management system. The financial management system supports a connection management framework of computing components associated with generating, presenting, and exporting underwriting analytics recommendations.

At a high level, the contextual underwriting analytics engine provides a technical solution for analyzing financial data, generating insights, and presenting and exporting contextual underwriting analytics recommendations. The contextual underwriting analytics engine integrates qualitative data (e.g., client profile data) and quantitative data (e.g., raw financial documents) using a contextual underwriting analytics model and augmented analytics rules. By integrating qualitative client profile data and quantitative client financial data, the contextual underwriting analytics engine offers a holistic approach for understanding and managing clients' financial situation.

By way of example, we have a client named Kaitlin, a successful entrepreneur with multiple business ventures. Kaitlin operates various businesses, each structured as a Limited Liability Company (LLC), and she receives K1 forms annually for each LLC. The contextual underwriting analytics engine begins by integrating qualitative client profile data. In Kaitlin's case, this includes a detailed biography outlining her entrepreneurial journey, her business objectives, and her long-term financial goals. Additionally, it captures information about Kaitlin's investment preferences, risk appetite, and personal background. This qualitative client profile data sets the context for analyzing Kaitlin's financial data.

Next, the contextual underwriting analytics engine processes Kaitlin's quantitative client financial data, for example K1 forms issued by each LLC. These forms provide insights into the financial activities of each business, including profits, losses, distributions, and contributions. Using a set of predefined rules and a contextual underwriting analytics model, the contextual underwriting analytics engine interprets the quantitative client financial data in light of the qualitative client profile data.

For example, it considers Kaitlin's business structure (LLC), understanding that LLC profits and losses flow through to her personal tax return via K1 forms. Moreover, it acknowledges Kaitlin's investment goals and risk tolerance, which may influence her decisions regarding distributions and contributions to each LLC.

Based on the rule-based interpretation, the contextual underwriting analytics engine generates actionable insights. For instance, it identifies the portions of income distributed to Kaitlin from each LLC and subtracts the contributions she made. This calculation yields a clearer picture of Kaitlin's net income from each business, which is important for assessing her creditworthiness or financial health. The contextual underwriting analytics engine maps qualitative client profile data to quantitative client financial data to generate human-readable insights. Finally, the contextual underwriting analytics engine compiles all the insights into a comprehensive report. This report not only presents Kaitlin's historical financial performance but also provides forward-looking projections based on her investment plans and business strategies. It tells a coherent story of Kaitlin's financial journey, from her entrepreneurial beginnings to her current ventures and future aspirations.

By leveraging both qualitative client data and quantitative financial data, the contextual underwriting analytics engine offers a robust framework for financial analysis and underwriting. In Kaitlin's case, it provides valuable insights into her business activities, income streams, and investment outlook, enabling stakeholders to make informed decisions aligned with her goals. This integrated approach not only enhances the underwriting process but also fosters a deeper understanding of clients' financial narratives.

Advantageously, the embodiments of the present technical solution include several inventive features (e.g., operations, systems, engines, and components) associated with a financial management system having a contextual underwriting analytics engine. The contextual underwriting analytics engine supports generating a contextual underwriting analytics recommendation as part of context-based underwriting in a financial management system. The contextual underwriting analytics resources are a solution to a specific problem (e.g., limitations in providing contextual and automated analysis of financial documents along with human-readable additional insights that explain to the user an appropriate context-specific way why certain data and computations are relevant for an underwriter's assessment). The contextual underwriting analytics model and augmented analytics rules provide an improvement in financial management technology in that they operate to improve computing operations for generating contextual underwriting analytics recommendations.

### EXAMPLE SYSTEMS AND RESOURCES

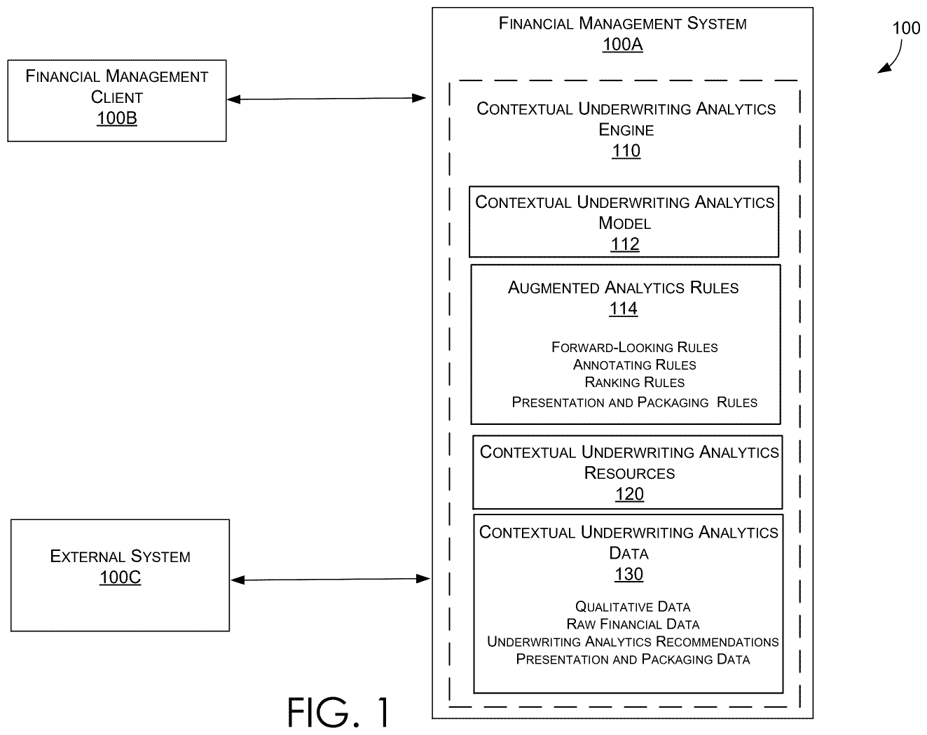

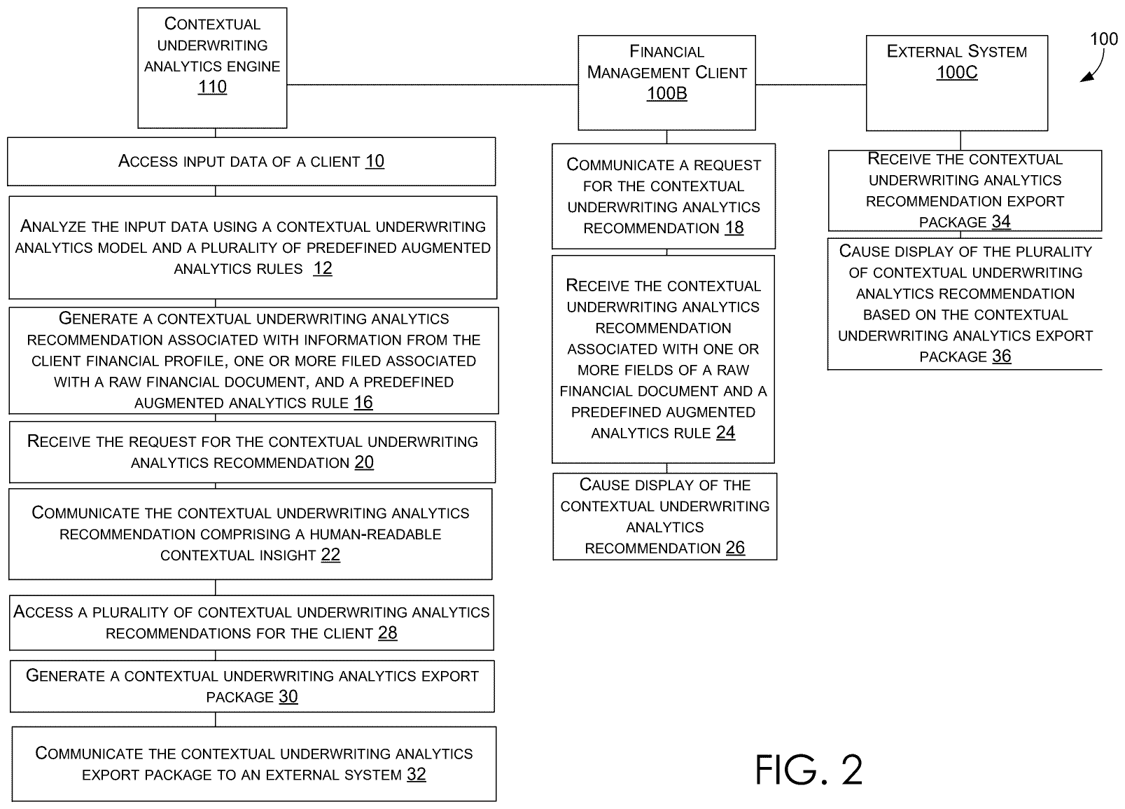

Aspects of the technical solution can be described by way of examples and with reference to FIGS. 1 and 2. FIG. 1 illustrates a cloud computing environment (system) 100, financial management system 100A, financial management client 100B, external system 100C, contextual underwriting analytics engine 110, contextual underwriting analytics model 112, augmented analytics rules 114, contextual underwriting analytics resources 120, and contextual underwriting analytics data 130.

The financial management system 100A provides a range of features to streamline various financial tasks, including accounting, budgeting, financial reporting, and analysis. The financial management client 100B operates with the financial management system to support context-based underwriting functionality. The external system 100C can refer to different types of financial management systems or client that receive output from the financial management system 100A. The external system can receive the output (e.g., contextual underwriting analytics export package) to cause generation of the contextual underwriting recommendations.

The contextual underwriting analytics model 112 is a machine learning framework that combines quantitative data with qualitative data to provide contextual understanding and support decision-making in the underwriting process. The contextual underwriting analytics model 112 employs a variety of techniques, including natural language processing (NLP), sentiment analysis, and predictive modeling, to analyze qualitative data and extract relevant features for underwriting decisions. The contextual underwriting analytics model 112 integrates forward-looking rules, annotating rules, ranking rules, and presentation and packaging rules to enrich qualitative data, prioritize insights, and package results for distribution to external systems. The contextual underwriting analytics model 112 learns from historical data, adapts to changing market conditions, and continuously improves its performance through iterative training and feedback mechanisms.

The contextual underwriting analytics resources 120 can include operations, interfaces, and data components that support context-based underwriting functionality. Operations, include data ingestion from diverse sources such as financial statements, credit reports, and industry data; preprocessing to clean and standardize the data; feature extraction to identify relevant variables and insights; rule application based on predefined augmented analytics rules encompassing forward-looking, annotating, ranking, and presentation criteria; and prediction using machine learning algorithms to forecast outcomes pertinent to underwriting decisions, and evaluation to assess the model's performance metrics.

Interfaces include data interfaces for seamless data exchange, user interfaces offering intuitive dashboards and visualization tools for interpretation, APIs and integration capabilities for interoperability with external systems, and a feedback loop mechanism for continuous improvement.

Data encompasses both quantitative and qualitative sources, including historical data for training and validation, contextual data for situational awareness, and diverse data types such as financial metrics, customer demographics, and industry reports, all contributing to informed underwriting decisions and optimized loan approval processes.

The contextual underwriting analytics engine 110 provides augmented analytics rules that include predefined criteria, algorithms, or guidelines used to enhance the process of data analysis and interpretation for context-based underwriting. Rules can include: forward-looking rules that are algorithms or criteria used to analyze qualitative data and predict future outcomes or trends relevant to underwriting decisions. These rules leverage historical data, market trends, and predictive modeling techniques to forecast potential changes in financial circumstances or risk factors that may impact the borrower's creditworthiness.

By way of illustration, a forward-looking rule may analyze qualitative data such as industry trends, macroeconomic indicators, and business projections to predict future revenue growth for a small business borrower, thereby informing underwriting decisions regarding loan eligibility and terms. Annotating rules involve the process of adding contextual annotations or metadata to qualitative data to enhance its interpretation and relevance for underwriting decisions. These rules help enrich qualitative and quantitative data by providing additional context, categorization, or labeling that facilitates underwriting assessments. An annotating rule may categorize qualitative data such as business objectives or long-term employment prospect into relevant themes or topics and assign descriptive labels or tags to each piece of data for easier analysis and interpretation by underwriters.

Ranking rules are criteria or algorithms used to prioritize and rank qualitative data, quantitative data, and contextual underwriting recommendations based on relevance, significance, or impact on underwriting decisions. These rules help identify the most important or influential pieces of data that should be given higher priority in the underwriting process. A ranking rule may evaluate qualitative data, quantitative data, and contextual underwriting recommendations based on criteria such as relevance to prioritize the most relevant data for consideration in underwriting decisions.

Presentation and packaging rules involve formatting and structuring qualitative data, quantitative data, and contextual underwriting recommendations into a coherent and informative format for distribution to external systems or stakeholders. These rules ensure that the qualitative data, quantitative data, and contextual underwriting recommendations are effectively communicated and understood by external parties. A presentation and packaging rule may format underwriting reports or decision summaries into standardized templates or dashboards, including key metrics, visualizations, and narrative descriptions, for distribution to external stakeholders such as loan officers, regulators, or investors.

With continued reference to FIG. 1, and by wat of illustration, the contextual underwriting analytics engine 110 operates based on qualitative client profile data that includes information about the client's background, biography, financial goals, and accomplishments. The qualitative client profile data set the stage for understanding the client's financial history and future plans. Qualitative client input data serves as a foundation for tailoring the financial analysis and recommendations to align with client's specific circumstances and objectives.

Raw financial data analysis is performed to analyze raw financial documents (e.g., tax returns, K-1 forms, and balance sheets). Raw financial data analysis identifies relevant financial activities, contributions, distributions, and other key metrics, and extracts insights from historical financial data to inform decision-making. Key metrics and financial activities are extracted from financial data including contributions, distributions, income, expenses and other relevant data.

The contextual underwriting analytics engine 110 further employs augmented analytics rules 114 for extracting relevant information from qualitative client profile data and quantitative client financial information, mapping the qualitative client profile data to quantitative client financial information, performing calculations, and generating and ranking human insights. The augmented analytics rules 114 are based contextual factors, documents, and input data that leveraging advanced technologies (e.g., contextual underwriting analytics model) to automate data analysis and interpretation, while also incorporating human expertise to provide meaningful insights. The augmented analytics rules 114 can be specifically associated with forward-looking (e.g., forward-looking rules) annotating with human-readable insights (e.g., annotating rules), ranking human-readable insights (e.g., ranking rules) and presentation and packaging (e.g., presentation and packaging rules).

By way of example, a company issues a K1 form to its shareholders, detailing the financial activity of the S Corp, including accounting data. When analyzing the K1 form for credit assessment purposes, attention is primarily directed towards two critical components: contributions (e.g., review the contributions made by the shareholders to the company, which are documented on the K1 form) and distributions (e.g., examine the distributions taken from the company and received by the shareholders, also outlined on the K1 form). Unlike traditional assessments of business income, the approach for S Corps shifts focus: rather than considering the total business income, the analysis zooms in on the income portion distributed to the owner(s) of the S Corp. To calculate the net income applicable to the borrower (owner), follow these steps: identify the portion of income distributed to the owner(s) as indicated on the K1 form; subtract any contributions made by the owner(s) to the company from the distributed income; the resulting figure represents the net income attributable to the borrower, providing a clearer view of their actual income from the S Corp. The credit assessment process for an S Corp involves examining the contributions and distributions outlined on the K1 form, with a specific focus on determining the net income applicable to the borrower by subtracting contributions from distributed income.

This and other types of scenarios can be defined as augmented analytics rules 114. For example, when evaluating individuals for loans or other financial purposes, it is important to consider the total income derived from all their LLCs, as reflected in the K1 forms. The distributions received from these LLCs significantly contribute to the individual's overall financial picture, even if they are not fully reflected in their personal tax returns. To accurately gauge an individual's income, it is important to refer to the K1 forms issued by their LLCs rather than solely relying on their personal tax returns. This is because the income reported on personal tax returns may not fully capture the earnings from all the LLCs.

Other rules can be associated with the significance of K1 in assessing total income. The K1 form, which is part of the corporate return (e.g., Form 1120), provides insights into the income received from all associated entities. While the K1 form may contain various entries, not all of them are relevant from an underwriting perspective. Entries like depreciation or stock transfers, while present, may not impact credit assessment directly. This total income may include substantial distributions that are not evident on the individual's personal tax return. In this way, the augmented analytics rules 114 focus on relevant pieces of information from the K1 form, those that directly influence the credit assessment, rather than extraneous details meant for tax purposes.

By way of another illustration, when individuals report their income on personal tax returns, it provides information on net cash flow and net income. However, this net income figure may not always reflect the true financial situation, especially when certain expenses like depreciation are considered. Depreciation is a tax deduction rather than an actual cash outflow. While depreciation reduces taxable income, it doesn't represent a physical expenditure. To accurately reflect the actual income from an underwriting perspective, it's necessary to add back line items, such as depreciation, to the reported net income. This adjustment ensures a more accurate reflection of the individual's financial position. Moreover, identifying and excluding one-time capital expenses from the assessment of ongoing income is important. For example, if a large capital expense, like purchasing a building, significantly impacts net income for a particular year, it may not accurately represent the individual's recurring income. In projecting future income or assessing creditworthiness, it's important to distinguish between one-time expenses and recurring operational costs. One-time expenses, like capital investments, may skew the financial picture if carried forward into future projections without proper adjustment. As such, augmented analytics rules can be defined to correctly capture quantitative data and map to qualitative data for generation underwriting assessments that integrate the qualitative data in underwriting analytics recommendations.

The contextual underwriting analytics engine 110 generates a contextual underwriting analytics export package. The contextual underwriting analytics export package can include analyzed financial data and insights that are stored in a structured format for presentation. The contextual underwriting analytics export package can include instructions for presenting the information to ensure clarity and relevance. The contextual underwriting analytics export package and presentation instructions can emphasize for presentation important insights and findings for easy understanding by stakeholders.

With reference to FIG. 2, FIG. 2 illustrates cloud computing environment 100 including contextual underwriting analytics engine 110, financial management client 100B, and external system 100C.

At block 10, the contextual underwriting analytics engine 110 access input data associated with a client. The client is identified for an underwriting assessment. The input data includes qualitative client profile data including a client financial profile description and quantitative client financial data including raw financial documents. The client financial profile description includes the information about the client including a business objective and a long-term financial goal. The quantitative financial data comprises two or more different types of raw financial documents, where a first document type is a tax return and a second document type of a schedule K-1 document. The human read-able contextual insights is generated based on the business objective, the long-term financial goal, the tax return, and the schedule K-1 document.

At block 12, the contextual underwriting analytics engine 110 analyzes the input data using a contextual underwriting analytics model and a plurality of predefined augmented analytics rules. The contextual underwriting analytics model is a machine learning model that employs the plurality of predefined augmented analytics rules to map qualitative client profile data to quantitative client financial data, while simultaneously generating the human-readable contextual insight. The pre-defined augmented analytics rules include forward-looking rules, annotating rules, ranking rules, and presentation and packaging rules.

At block 14, the contextual underwriting analytics engine 110 generates a contextual underwriting analytics recommendation associated with information from the client financial profile, one or more fields associated with a raw financial document, and a predefined augmented analytics rule. The plurality contextual underwriting analytics recommendations are ranked and provided for presentation based on a ranking score of each contextual underwriting analytics recommendation. The plurality of contextual underwriting analytics recommendations are packaged and provided for exportation to an external system.

At block 18, the financial management client 100B communicates a request for the contextual underwriting analytics recommendation. At block 20, the contextual underwriting analytics engine 110 receives the request for the contextual underwriting analytics recommendation; communicates the contextual underwriting analytics recommendation comprising a human-readable contextual insight. At block 24, the financial management client receives the contextual underwriting analytics recommendation; and at block 26, causes display of the contextual underwriting analytics recommendation.

At block 28, the contextual underwriting analytics engine 110 accesses a plurality of contextual underwriting analytics recommendations for a client; at block 30, generates a contextual underwriting analytics export package using the contextual underwriting analytics model and the plurality of predefined augmented analytics rules; at block 31, communicates the contextual underwriting analytics export package to the external system 100C. At block 34, the external system 100C receives the contextual underwriting analytics export package; and at block 36, causes display of the plurality of contextual underwriting analytics recommendation based on the contextual underwriting analytics export package.

### Example Methods

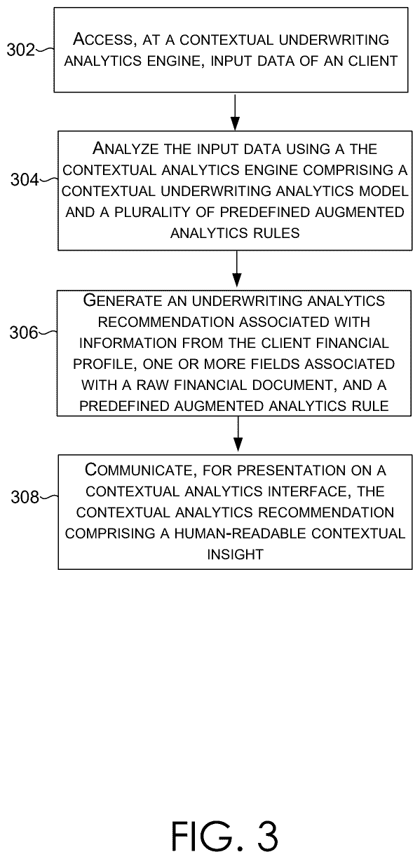

With reference to FIGS. 3, 4, and 5, flow diagrams are provided illustrating methods for providing context-based underwriting using a contextual underwriting analytics engine in a financial management system. The methods may be performed using the financial management system described herein. In embodiments, one or more computer-storage media having computer-executable or computer-useable instructions embodied thereon that, when executed, by one or more processors can cause the one or more processors to perform the methods (e.g., computer-implemented method) in the financial management system (e.g., a computerized system).

Turning to FIG. 3, a flow diagram is provided that illustrates a method 300 for providing context-based underwriting using a contextual underwriting analytics engine of a financial management system. At block 302, access, at a contextual underwriting analytics engine, input data associated with a client identified for an underwriting assessment, the input data comprising qualitative client profile data including a client financial profile description and quantitative client financial data including raw financial documents. At block 304, analyze the input data using a contextual underwriting analytics model and a plurality of predefined augmented analytics rules. At block 306, generate a contextual underwriting analytics recommendation associated with information from the client financial profile, one or more fields associated with a raw financial document, and a predefined augmented analytics rule. At block 308, communicate, for presentation on a contextual underwriting analytics interface, the contextual underwriting analytics recommendation comprising a human-readable contextual insight.

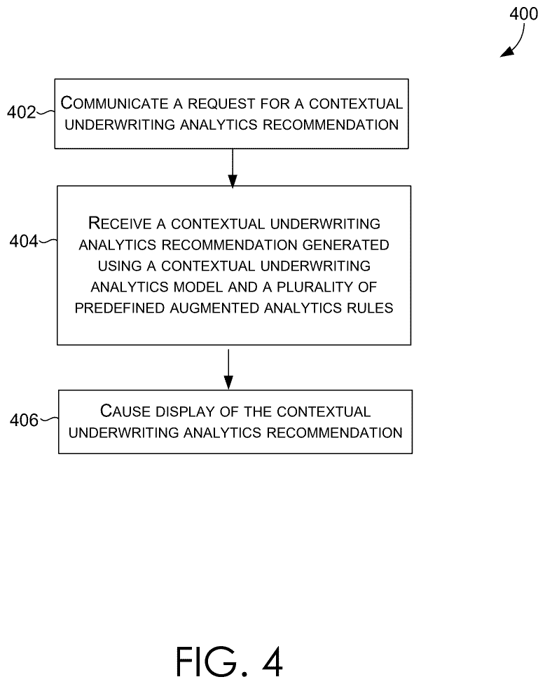

Turning to FIG. 4, a flow diagram is provided that illustrates a method 400 for providing context-based underwriting using a contextual underwriting analytics engine of a financial management system. At block 402, communicate a request for a contextual underwriting analytics recommendation for a client a financial management client; at block 404, based on communicating the request, a contextual underwriting analytics recommendation is received, the contextual underwriting analytics recommendation is generated using a contextual underwriting analytics model and a plurality of predefined augmented analytics rules; and at block 406, cause display of the contextual underwriting analytics recommendation comprising a human-readable contextual insight.

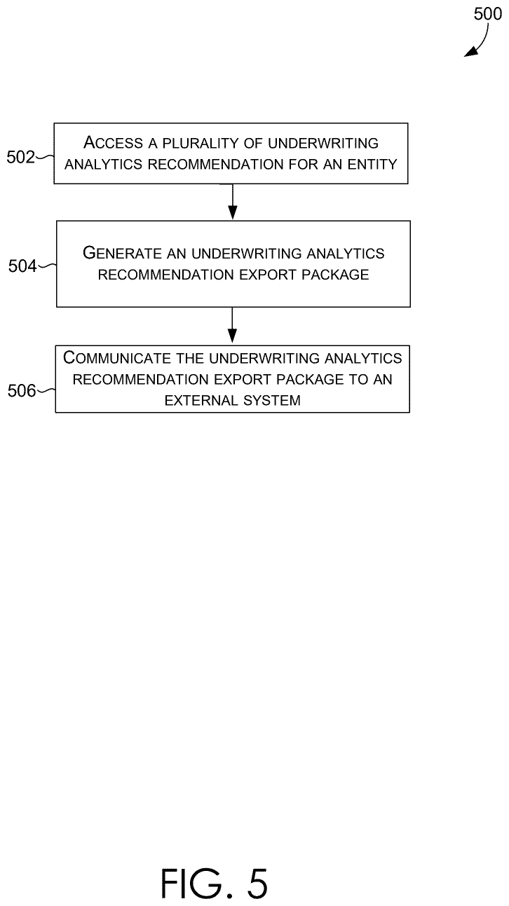

Turning to FIG. 5, a flow diagram is provided that illustrates a method 500 for providing context-based underwriting using a contextual underwriting analytics engine of a financial management system. At block 502, access a plurality of contextual underwriting recommendations for a client; at block, 504, generate a contextual underwriting analytics export package comprising a plurality of contextual underwriting analytics recommendations; and at block 506, communicate the contextual underwriting analytics export package to an external system.

### Technical Improvement

Embodiments of the present techniques have been described with reference to several inventive features (e.g., operations, systems, engines, and components) associated with a financial management system. Inventive features described include: operations, interfaces, data structures, and arrangements of computing resources associated with providing the functionality described herein relative with reference to a contextual underwriting analytics engine. Functionality of the embodiments of the present invention have further been described, by way of an implementation and anecdotal examples—to demonstrate that the operations for providing the contextual underwriting analytics engine as a solution to a specific problem in financial management technology to improve computing operations in financial management systems.

By way of example, the underwriting analytics engine supports unified device management resources that enable supports generating a contextual underwriting analytics recommendation as part of context-based underwriting in a financial management system. The contextual underwriting analytics resources are a solution to a specific problem (e.g., limitations in providing contextual and automated analysis of financial documents along with human-readable additional insights that explain to the user an appropriate context-specific way why certain fields and computations are relevant for an underwriter's assessment). The contextual underwriting analytics model and augmented analytics rules provide an improvement in financial management technology in that they operate to improve computing operations for generating contextual underwriting analytics recommendations.

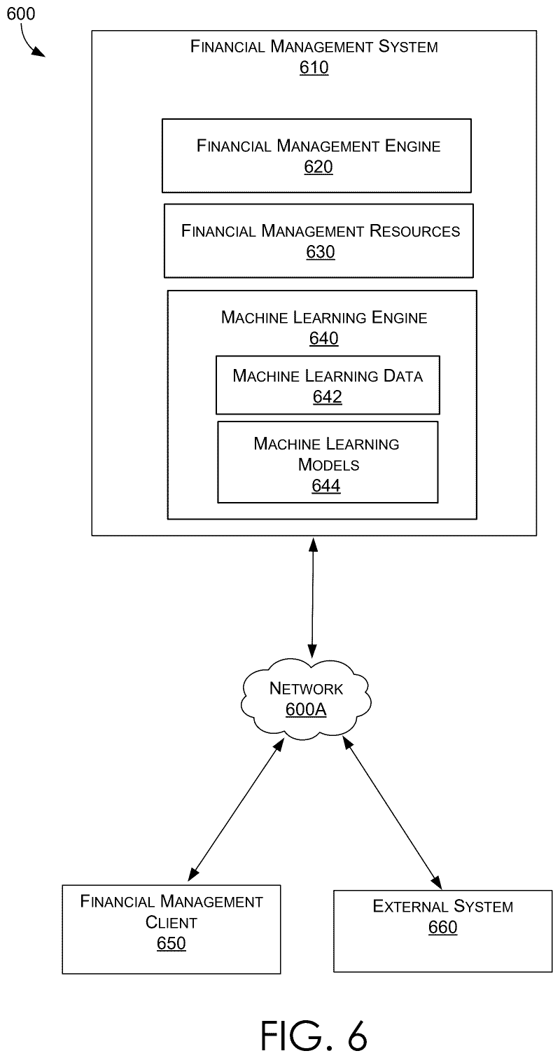

Aspects of the technical solution have been described by way of examples and with reference to FIGS. 1 and 2 FIG. 1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1 illustrates a high level architecture of the cloud computing system 100 in accordance with implementations of the present disclosure, among other engines, managers, generators, selectors, or components not shown (collectively referred to herein as “components”).

### Additional Support for Detailed Description Example Financial Management System in a Computing Environment

Referring now to FIG. 6, FIG. 6 illustrates a computing environment in which implementations of the present disclosure may be employed. In particular, FIG. 6 shows a high level architecture of an example cloud computing platform 600 and financial management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services-including compute, servers, storage, databases, networking, and intelligence. The components of cloud computing environment 600 may communicate with each other over a network 600A which may include, without limitation, one or more local area networks (LANs) and/or wide area networks (WANs).

The financial management system 610 provides financial management functionality for devices in computing environments. The financial management system 610 ensures streamlined execution of various financial tasks, including accounting, budgeting, financial reporting, and analysis. Financial management system 610 can include analytics tools to analyze financial data and trends, identify opportunities for cost savings or revenue growth, and make data-driven decisions. In this way, a financial management systems can include tools for financial modeling, scenario analysis, key performance indicators (KPI) tracking, and underwriting.

The financial management system 610 includes a financial management engine that is a computing environment that supports executing computational tasks associated with the financial management system 610. The financial management engine 620 can be a hardware or software component that performs computational operations, such as, mathematical calculations, data processing, and algorithm execution. The financial management system 610 integrates financial management resources 630 into financial management system 610 to effectively provide device management in a computing environment.

The financial management system 630 refer to computing elements (e.g., components, capability, or entities) that collectively enable the financial management engine 620 operations. The financial management resources 630 encompass a spectrum of computing elements, beginning with the diverse operations the financial management resources 630 can perform, ranging from complex computations to data manipulations. Interfaces, an integral part of the financial management resources 630, provide the means for both user interaction and seamless integration with external systems, ensuring a dynamic and interactive computing experience. The data facet of the financial management resources 630 involves various types: input data, which is the information provided for processing; processing data, representing the data manipulated during computational tasks; and output data, the results generated by the financial management engine 620. In this way, the device management resource 112 support the broader financial management engine 620 and financial management system 610. The financial management resources 620 can include contextual underwriting management resources that encompass the core operations, interfaces, and data components within financial management system 110.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The financial management client 650 supports access to financial management system 610 to deliver financial insights and analysis. Users on the financial management client input financial data, configure augmented analytics rules based on their specific needs, and initiate analysis processes. Once executed, the results of the analysis are presented on the financial management client 650 where users review visualizations, reports, and dashboards showcasing key findings and recommended actions derived from the applied rules. Users can then interact with the insights, exploring data visualizations, delving into detailed analysis, and collaborating with colleagues to interpret results and make informed decisions.

The external system 660 represents an external financial management system that operates with the financial management system 610. The external system can be a financial management platform that aggregates data from various sources, including underwriting systems, banking institutions, investment accounts, and market data providers. The external system 660 receives output from the financial management system 610. The external system 660 can provide a user-friendly interface where financial professionals, analysts, and decision-makers can access and review the underwriting recommendations in context with other financial data and insights. Users can explore detailed reports, visualizations, and dashboards that present the underwriting recommendations alongside relevant financial metrics, market trends, and portfolio performance indicators.

### Example Distributed Computing System Environment

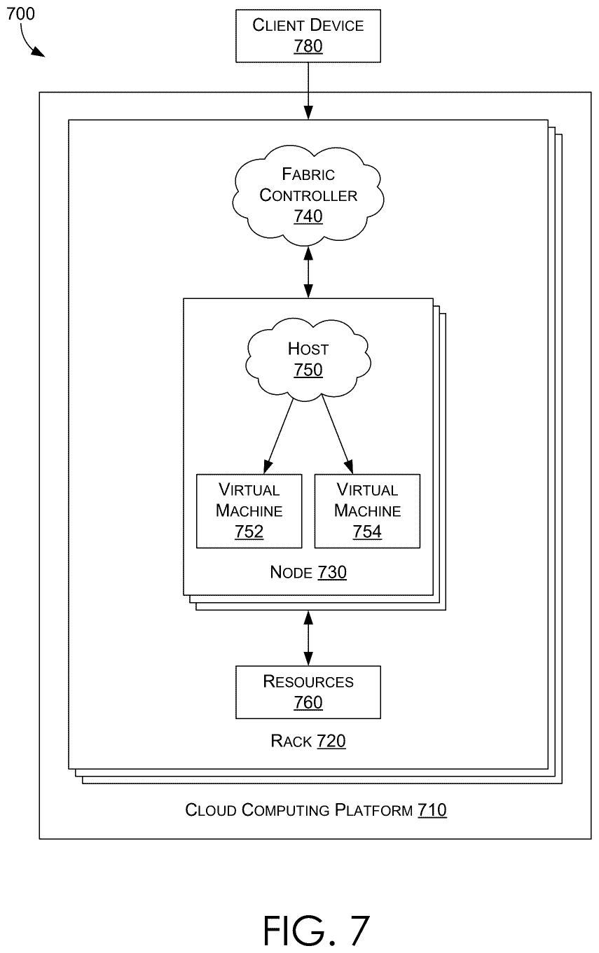

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

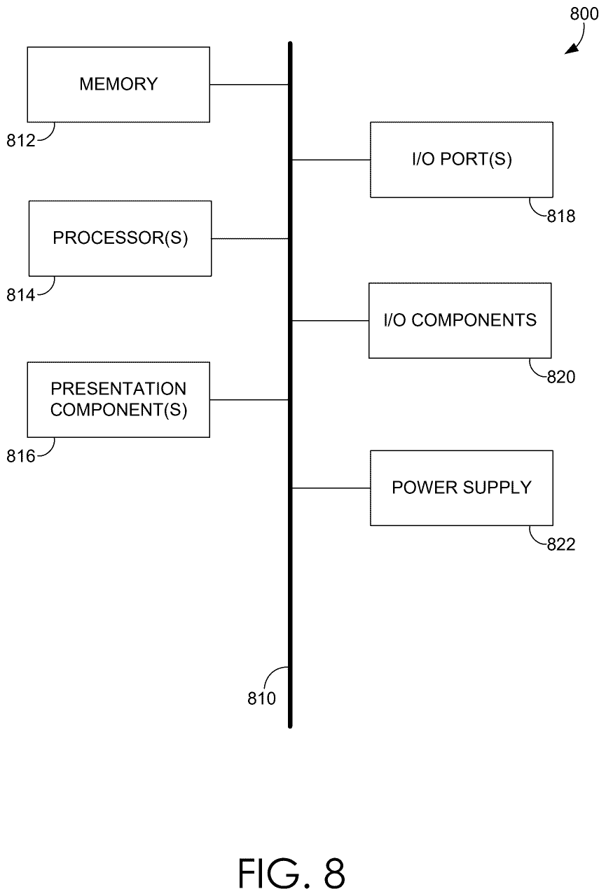

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing, at a contextual underwriting analytics engine, input data associated with a client identified for an underwriting assessment, the input data comprising qualitative client profile data including a client financial profile description and quantitative client financial data including raw financial documents;
analyzing the input data using a contextual underwriting analytics model and a plurality of predefined augmented analytics rules;
based on analyzing the input data using the contextual underwriting analytics engine, generating a contextual underwriting analytics recommendation associated with information from the client financial profile, one or more fields associated with a raw financial document, and a predefined augmented analytics rule; and
communicating, for presentation on a contextual underwriting analytics interface, the contextual underwriting analytics recommendation comprising a human-readable contextual insight.

2. The system of claim 1, wherein the client financial profile description includes the information about the client including a business objective and a long-term financial goal, and wherein the quantitative financial data comprises two or more different types of raw financial documents, wherein a first document type is a tax return and a second document type of a schedule K-1 document.

3. The system of claim 2, wherein the human read-able contextual insight is generated based on the business objective, the long-term financial goal, the tax return, and the schedule K-1 document.

4. The system of claim 1, wherein the contextual underwriting analytics model is a machine learning model that employs the plurality of predefined augmented analytics rules to map qualitative client profile data to quantitative client financial data, while simultaneously generating the human-readable contextual insight.

5. The system of claim 1, wherein the pre-defined augmented analytics rules include forward-looking rules, annotating rules, ranking rules, and presentation and packaging rules.

6. The system of claim 1, wherein a plurality contextual underwriting analytics recommendations are ranked and provided for presentation based on a ranking score of each contextual underwriting analytics recommendation.

7. The system of claim 1, wherein a plurality of contextual underwriting analytics recommendations are packaged and provided for exportation to an external system.

8. The system of claim 1, the operations further comprising:
communicating a request for the contextual underwriting analytics recommendation;
based on communicating the request for the contextual underwriting analytics recommendation, receive the contextual underwriting analytics recommendation; and
causing display of the contextual underwriting analytics recommendation comprising the human-readable contextual insight.

9. One or more computer-storage media having computer-executable instructions embodied thereon that, when executed by a computing system having a processor and memory, cause the processor to perform operations, the operations comprising:
communicating a request for a contextual underwriting analytics recommendation for a client a financial management client;
based on communicating the request, a contextual underwriting analytics recommendation is received, the contextual underwriting analytics recommendation is generated using a contextual underwriting analytics model and a plurality of predefined augmented analytics rules; and
causing display of the contextual underwriting analytics recommendation comprising a human-readable contextual insight.

10. The media of claim 9, wherein the contextual underwriting analytics model is a machine learning model that employs the plurality of predefined augmented analytics rules to map qualitative client profile data to quantitative client financial data, while simultaneously generating the human-readable contextual insight.

11. The media of claim 9, wherein the contextual underwriting analytics recommendations are associated with input data comprising qualitative client profile data including a client financial profile description and quantitative client financial data including raw financial documents.

12. The media of claim 9, wherein the client financial profile description includes the information about the client including a business objective and a long-term financial goal, and wherein the quantitative financial data comprises two or more different types of raw financial documents, wherein a first document type is a tax return and a second document type of a schedule K-1 document.

13. The media of claim 12, wherein the human read-able contextual insight is generated based on the business objective, the long-term financial goal, the tax return, and the schedule K-1 document.

14. A computer-implemented method, the method comprising:
accessing a plurality of contextual underwriting recommendations for a client;
using a contextual underwriting analytics model and a plurality of predefined augmented analytics rules, generating a contextual underwriting analytics export package comprising a plurality of contextual underwriting analytics recommendations; and
communicating the contextual underwriting analytics export package to an external system.

15. The method of claim 14, wherein the plurality of contextual underwriting analytics recommendations are associated with input data comprising qualitative client profile data including a client financial profile description and quantitative client financial data including raw financial documents.

16. The method of claim 14, wherein the client financial profile description includes the information about the client including a business objective and a long-term financial goal, and wherein the quantitative financial data comprises two or more different types of raw financial documents, wherein a first document type is a tax return and a second document type of a schedule K-1 document.

17. The method of claim 16, wherein human read-able contextual insight corresponding to each of the plurality of contextual underwriting analytics recommendations are generated based on the business objective, the long-term financial goal, the tax return, and the schedule K-1 document.

18. The method of claim 14, wherein the contextual underwriting analytics model is a machine learning model that employs the plurality of predefined augmented analytics rules to map qualitative client profile data to quantitative client financial data, while simultaneously generating human-readable contextual insights.

19. The method of claim 14, wherein the pre-defined augmented analytics rules include forward-looking rules, annotating rules, ranking rules, and presentation and packaging rules.

20. The method of claim 14, wherein the plurality contextual underwriting analytics recommendations are ranked and provided for presentation based on a ranking score of each contextual underwriting analytics recommendation.
